(19) United States
(12) Patent Application Publication
(10) Pub. No.: US 2012/0183924 A1
(43) Pub. Date: Jul. 19, 2012

(54) PROSTHETIC DENTAL DEVICE WITH BRIDGE HAVING CLASPING ARM

(76) Inventor: TAI-WU LIN, Taipei City (TW)

(21) Appl. No.: 13/006,422

(22) Filed: Jan. 14, 2011

(51) Int. Cl. A61C 13/267

(52) U.S. Cl. 433/178

(57) ABSTRACT

A prosthetic tooth having a bridge clasping arm and a clasping structure is disclosed. The prosthetic tooth includes a prosthetic tooth and at least one bridge clasping arm. The bridge clasping arm is connected to one side of the prosthetic tooth and includes a first clasping portion, which is formed on an inside surface of the bridge clasping arm. A second clasping portion is provided on an adjacent tooth, which corresponds to the bridge clasping arm. When the bridge clasping arm is positioned on the adjacent tooth, the first clasping portion and the second clasping portion engage each other for clasping. The present inventions uses the bridge clasping arm for connection with an adjacent tooth in order to improve the capability of the prosthetic tooth for bearing forces acting thereon.

### (a) TECHNICAL FIELD OF THE INVENTION

The present invention generally relates to a prosthetic dental device, and more particularly to a bridge having clasping arms that are provided with clasping structure.

### (b) DESCRIPTION OF THE PRIOR ART

When natural teeth are damaged, chewing capability is affected, which in turn leads to poor digestion performance of intestines and stomach. A denture or partial denture is often used, by being mounted to the natural teeth, for the purposes of protection and enhanced capability of resisting forces acting thereon, so as to provide the damaged natural teeth with sufficient mechanical strength for chewing.

When the gum and alveolar bone around the natural teeth is severely damaged, the denture, even properly mounted, is not capable of supporting the pressure applied thereto in chewing food. A common solution is to arrange a bridge on at least one side of a prosthetic tooth. The bridge has clasping arms that clasp the adjacent teeth, which serve as abutment, to improve the strength of the prosthetic tool to support force applied thereto.

Further, to make cleaning operations of the dentures simple, a removable prosthetic dental device that is composed of internal and external crowns is available. Such a prosthetic dental device comprises clasping arms of bridge on both sides thereof. Such a prosthetic dental device restores the chewing capability of a dental patient and allows for removal from the oral cavity for cleaning.

However, such a prosthetic dental device suffers instability of mounting, for the internal and external crowns are fixed to each other through frictional force. If the frictional force is insufficient, the external crown gets easy detachment in chewing food, especially sticky foodstuffs. On the other hand, when the frictional force gets excessively large, it would makes the external crown sticking to the internal crown and hard or even impossible to remove.

Further, the positioning angle between adjacent teeth is often very precise. Any deviation in mounting position of the denture may cause uncomfortableness and even lead to non-uniform distribution of force applied to the denture in chewing food, eventually damaging the denture.

### SUMMARY OF THE INVENTION

In view of the above discussed problems, the present invention provides a prosthetic tooth having a bridge clasping arm and a clasping structure. The prosthetic tooth comprises a prosthetic tooth and at least one bridge clasping arm. The bridge clasping arm is connected to one side of the prosthetic tooth and comprises a first clasping portion and a second clasping portion is provided on an adjacent tooth, which corresponds to the bridge clasping arm. When the bridge clasping arm is positioned on the adjacent tooth, the first clasping portion and the second clasping portion engage each other for clasping.

An objective of the present invention is to ensure more reliable connection of the prosthetic tooth that comprises a bridge clasping arm and provides the advantages of easy mounting and removal.

The present inventions uses the bridge clasping arm for connection with an adjacent tooth in order to improve the capability of the prosthetic tooth for bearing forces acting thereon. Further, the present invention allows for easy removal for cleaning thereby facilitating the cleaning and caring of the prosthetic tooth. To mount the present invention, it can be directly set on a proper location and a user does not need to apply personal perception to identify if the device is properly mounted at a correct location. The efficient mounting to a proper location can be achieved to ensure protection and stabilization of the prosthetic tooth.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an embodiment of the present invention applied to teeth.

FIG. 2 is a perspective view showing mounting the embodiment of the present invention to teeth.

FIG. 3 is a perspective view of the embodiment of the present invention taken from a different perspective.

FIGS. 4 and 5 are cross-sectional views showing mounting the embodiment of the present invention to teeth.

FIG. 6 is a perspective view showing another embodiment of the present invention where a movable section is included.

FIG. 7 is a perspective view showing a further embodiment of the present invention where an internal crown is first mounted to an adjacent tooth.

FIG. 8 is a perspective view showing mounting of an internal crown according to said further embodiment of the present invention to an adjacent tooth.

FIG. 9 is a perspective view of said further embodiment of FIGS. 7 and 8 taken from a different perspective.

FIGS. 10-13 are cross-sectional views showing mounting said further embodiment of the present invention to an adjacent tooth that is first mounted with an internal crown.

FIG. 14 is a perspective view showing a further embodiment of the present invention where a movable section is included.

FIG. 15 is a perspective view showing an embodiment of the present invention where a prosthetic tooth is formed as an external crown.

FIG. 16 is an exploded view showing the embodiment of the present invention where the prosthetic tooth is formed as an external crown.

FIG. 17 is a perspective view of the embodiment of the present invention where the prosthetic tooth is formed as an external crown, taken from a different perspective.

FIG. 18 is a perspective view showing an embodiment of the present invention where a prosthetic tooth is formed as an external crown and is mounted to an adjacent tooth having an internal crown.

FIG. 19 is a perspective view showing the embodiment of the present invention where a prosthetic tooth is formed as an external crown and is mounted to an adjacent tooth having an internal crown.

FIG. 20 is a perspective view showing an embodiment of the present invention where a prosthetic tooth is formed as an external crown, taken from a different perspective.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

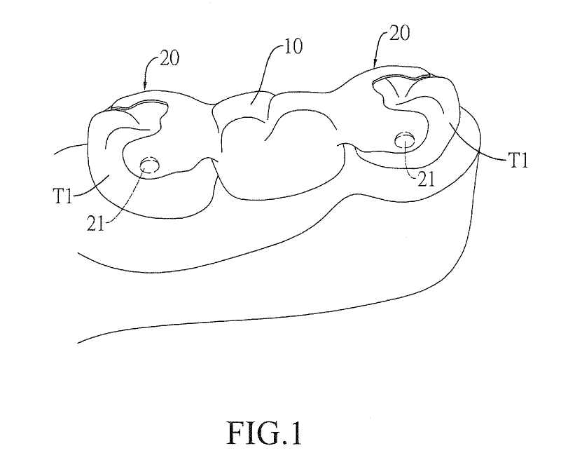

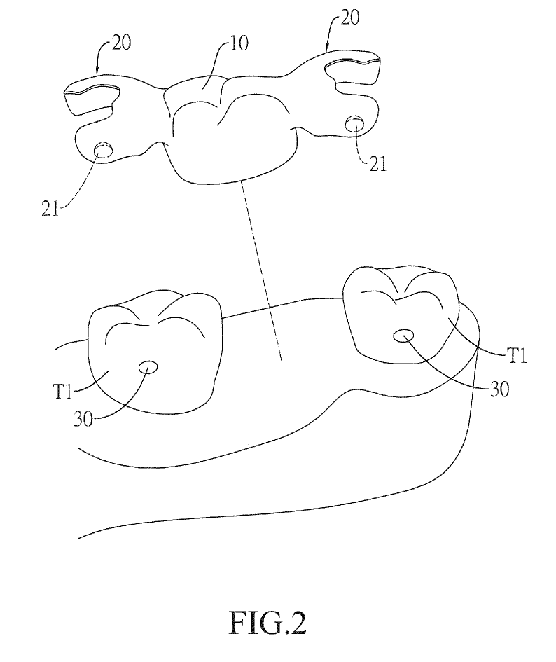

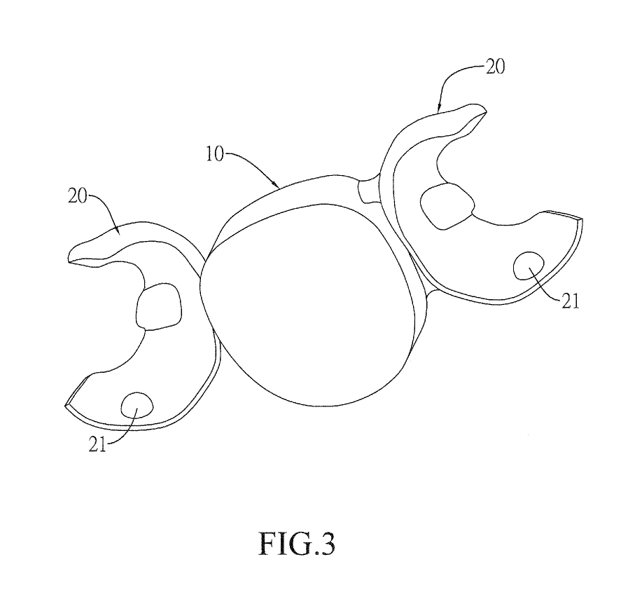

Referring to FIGS. 1-3, the present invention provides a prosthetic dental device that comprises a bridge clasping arm and a clasping structure according to an embodiment of the present invention. The embodiment comprises a prosthetic tooth 10 and at least one bridge clasping arm 20. Further, the embodiment will be explained with reference to such an arrangement that two bridge clasping arms 20 are provided to the prosthetic tooth 10. However, it is understood that the present invention is not limited to such specific number and may comprise a number of prosthetic teeth 10 connected together and bridge clasping arms 20 are provided to the opposite side prosthetic teeth 10. This arrangement is certainly within the scope of the present invention to be protected by what defined in the attached claims.

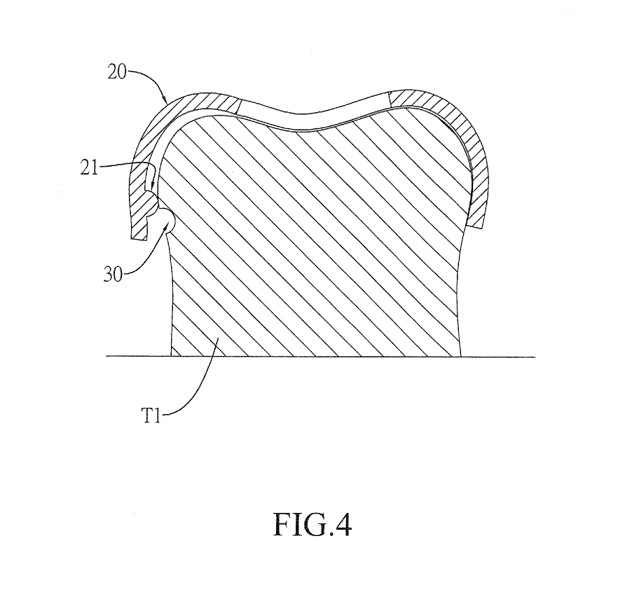

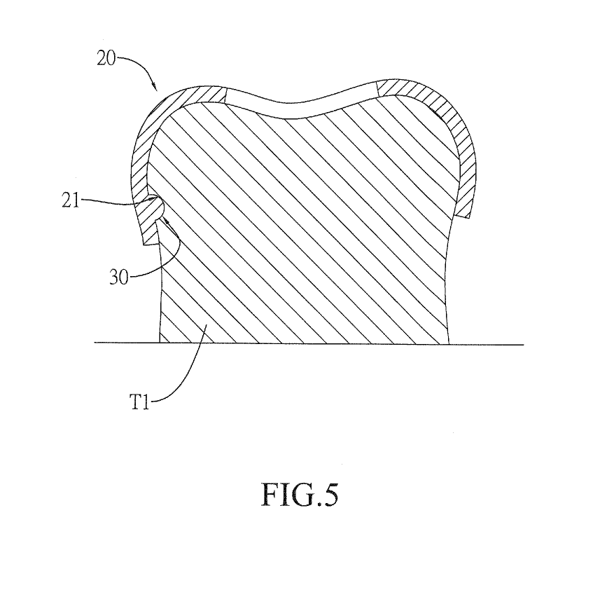

Referring to FIGS. 4 and 5, each bridge clasping arm 20 comprises a first clasping portion 21. The bridge clasping arm 20 is connected to a side of the prosthetic tooth 10 and comprises a first clasping portion 21, which is formed on an inside surface of the bridge clasping arm 20. Further, an adjacent tooth T1 that is located on one side of the prosthetic tooth is provided with a second clasping portion 30. The adjacent tooth T1 corresponds in position and configuration to the bridge clasping arm 20. When the bridge clasping arm 20 is positioned on the adjacent tooth T1, the first clasping portion 21 and the second clasping portion 30 engage each other for clasping.

When the prosthetic tooth 10 is set in a desired position, the first clasping portion 21 of the bridge clasping arm 20 engages the second clasping portion 30 so as to securely fix the prosthetic tooth 10 between adjacent teeth. Further, the bridge clasping arm 20 is made resilient, allowing outward deflection, as shown in FIGS. 4 and 5, in order to make the first clasping portion 21 smoothly pass the surface of the adjacent tooth T1 to engage the second clasping portion 30. To remove the prosthetic tooth 10, the bridge clasping arm 20 is deflected outward to disengage the first clasping portion 21 from the second clasping portion 30 thereby realizing separation of the prosthetic tooth. The embodiment of the present invention adopts clasping engagement between the first clasping portion 21 and the second clasping portion 30 to ease the mounting of the prosthetic tooth so that a user may easy remove the prosthetic dental device by himself or herself.

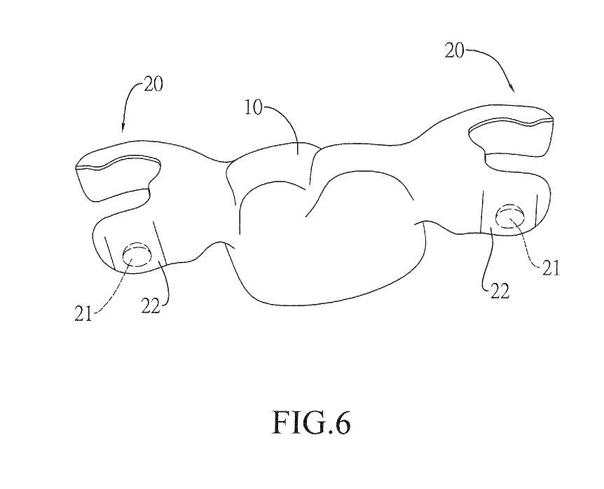

Further, referring to FIG. 6, the bridge clasping arm 20 may further be provided with a movable section 22. The movable section 22 is formed by partially cutting a portion of the bridge clasping arm 20 to form a deflectable or liftable structure, and the first clasping portion 21 is provided on the movable section 22. The movable section 22 is deflectable outward with respect to the bridge clasping arm 20, so as to allow for adjustment of the distance between the first clasping portion 21 and the surface of the adjacent tooth T1 for easily performing clasping engagement with the second clasping portion 30. To remove the prosthetic tooth 10, it only needs to deflect the movable section 22 outward to disengage the first clasping portion 21 from the second clasping portion 30, so that detachment of the prosthetic tooth 10 can be realized. The movable section 22 improves operation smooth of clasping and dismounting between the first clasping portion 21 and the second clasping portion 30.

Further, as shown in FIGS. 4 and 5, the first clasping poi lion 21 comprises a raised block or projection, while the second clasping portion 30 is a recess or dimple corresponding thereto for easy manufacture and use.

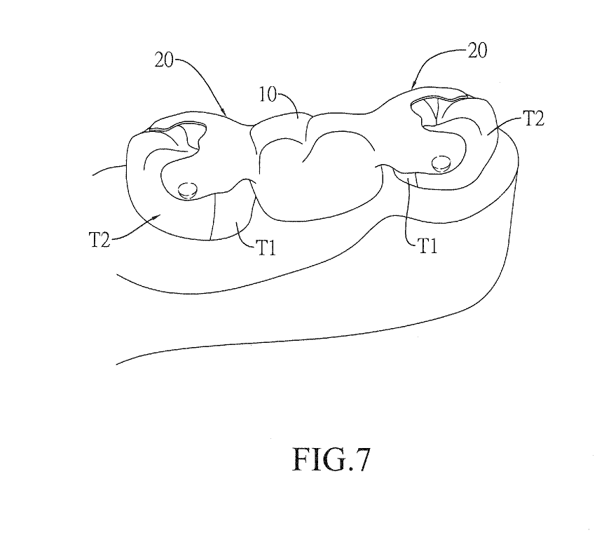

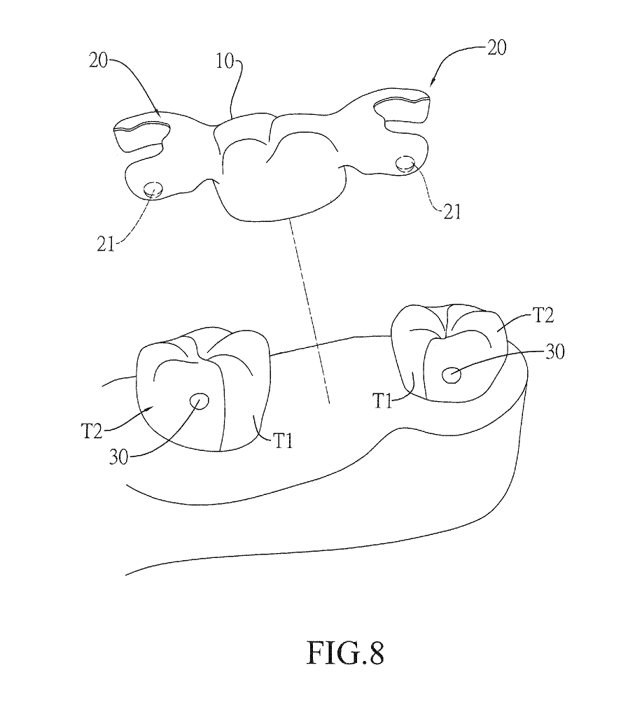

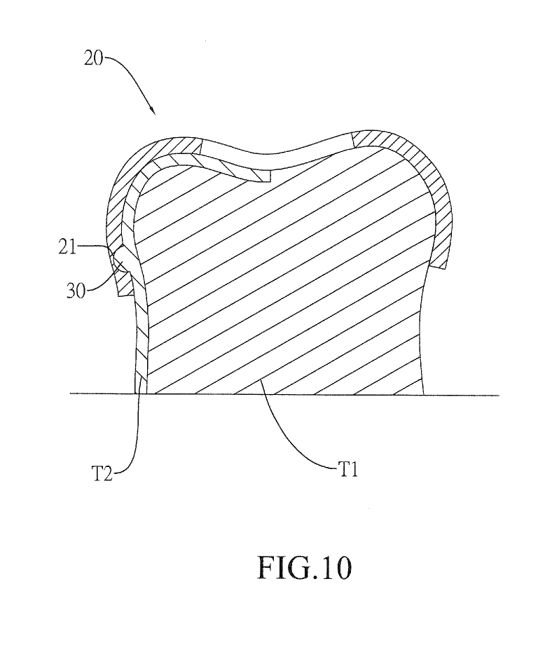

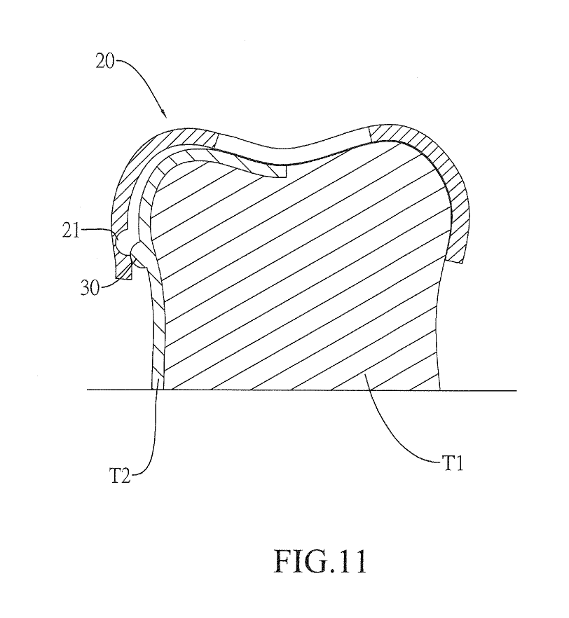

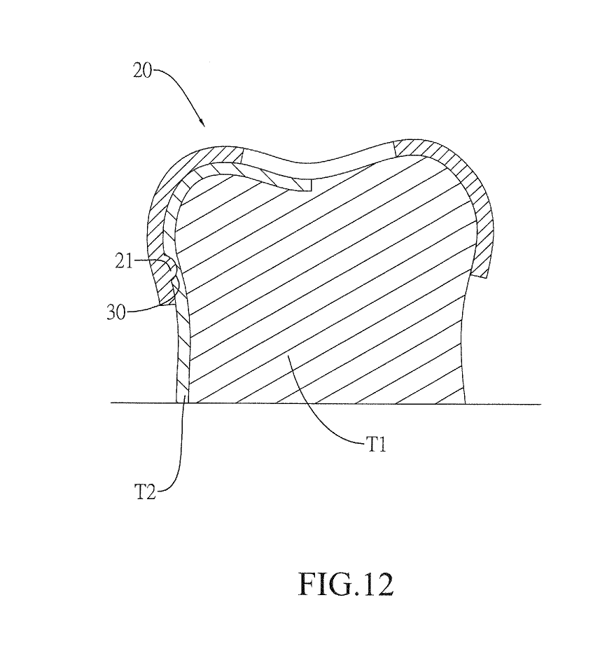

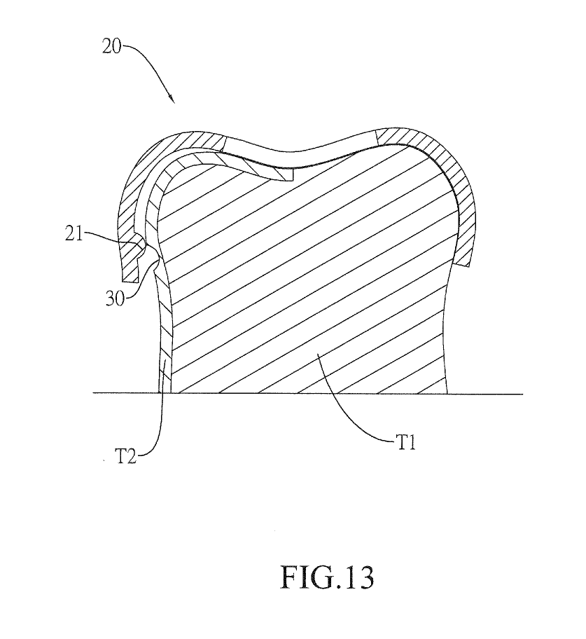

Further, as shown in FIGS. 7-13, in case that the surface of the adjacent tooth T1 is irregular or requires partial restoration, an internal crown T2 can be set on the adjacent tooth T1 for protection. The second clasping portion 30 is formed on the internal crown T2 in order to realize the same clasping purposes as the previous embodiment. Further, the internal crown T2 can be mounted to any portion of the surface of the adjacent tooth, not limited to what shown in the drawings.

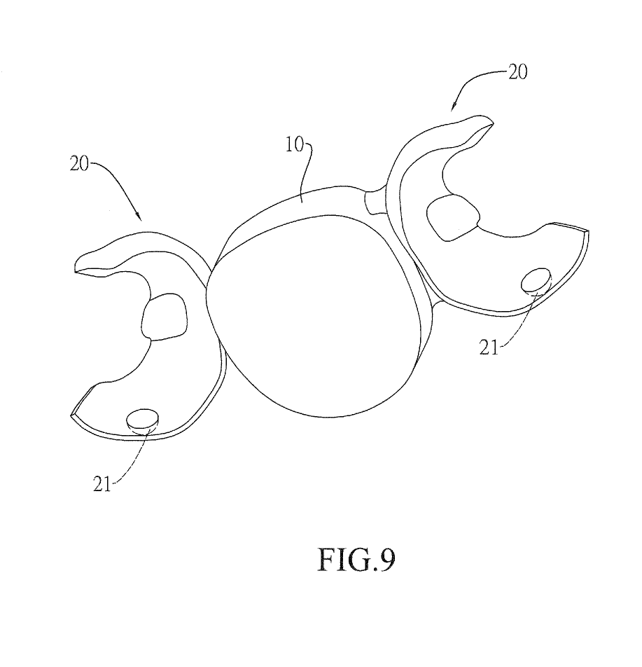

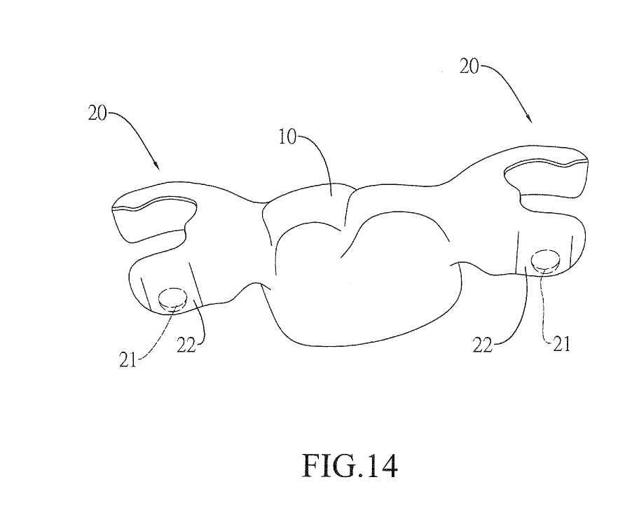

The second clasping portion 30 is formed on an internal crown T2 and is attached to the adjacent tooth T1 by means of the internal crown T2. Referring to FIGS. 9-15, the first clasping portion 21 and the second clasping portion 30 are preferably corresponding dimple and projection. When the second clasping portion 30 is a projection, the first clasping portion 21 is dimple corresponding to the projection; and when the second clasping portion 30 is a dimple, the first clasping portion 21 is projection corresponding to the dimple. In this way, the first clasping portion 21 and the second clasping portion 30 can easily engage each other for clasping. Further, as shown in FIG. 14, the bridge clasping arm 20 may also be provided with a movable section 22 for easing the operation of mounting and removal.

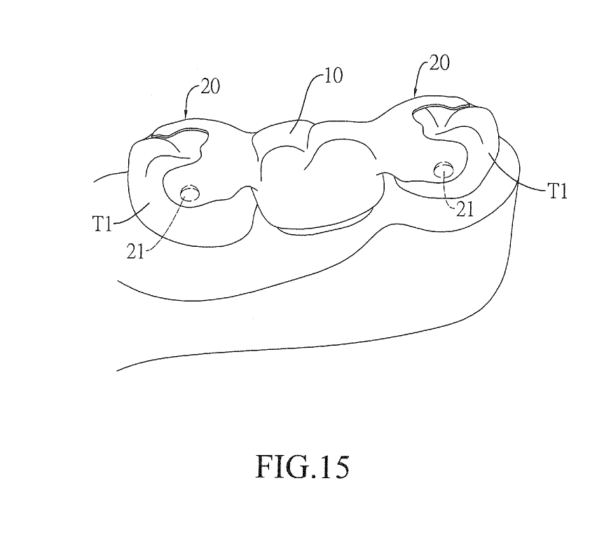

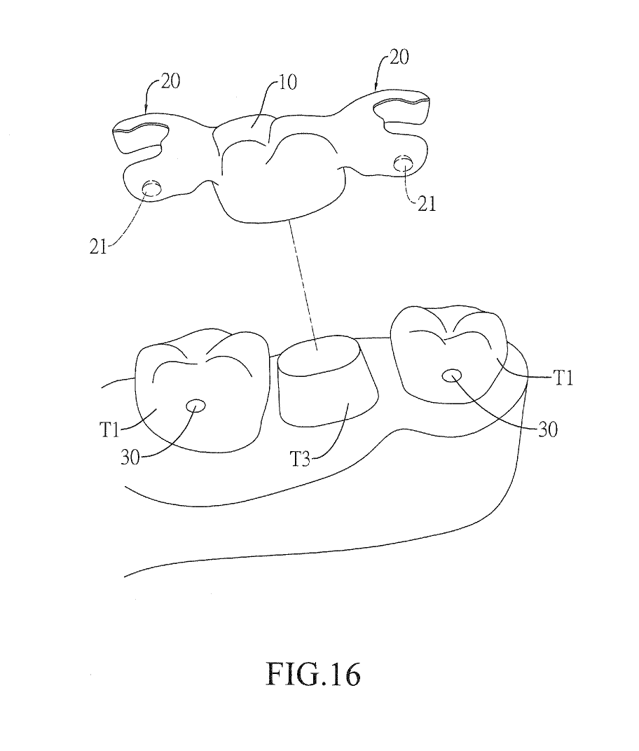

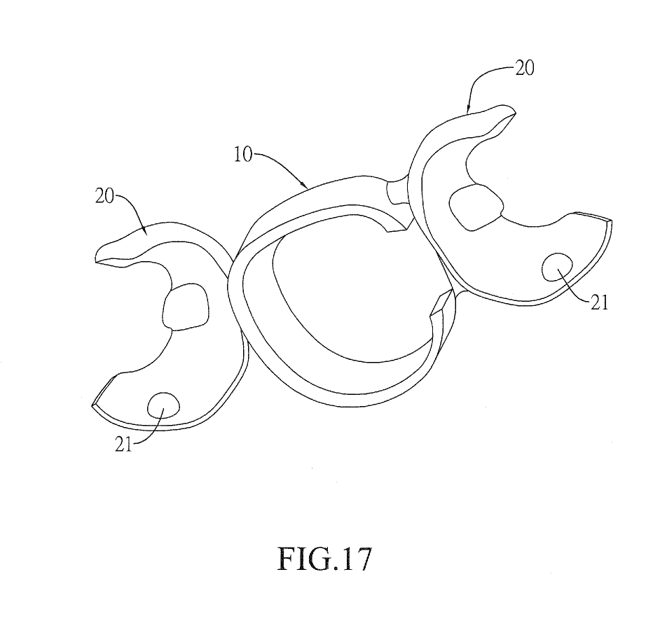

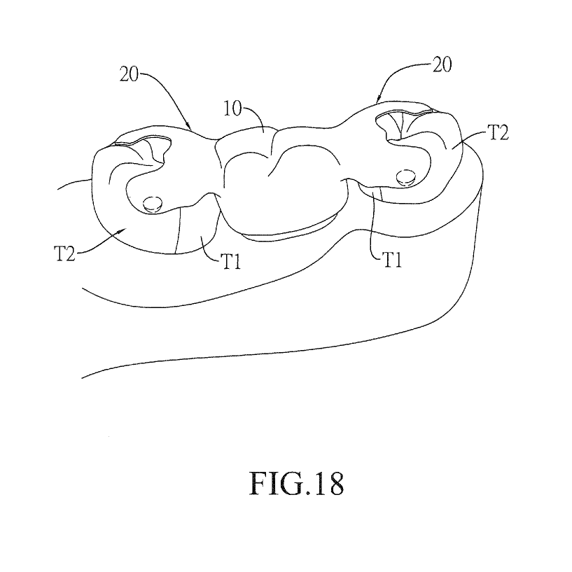

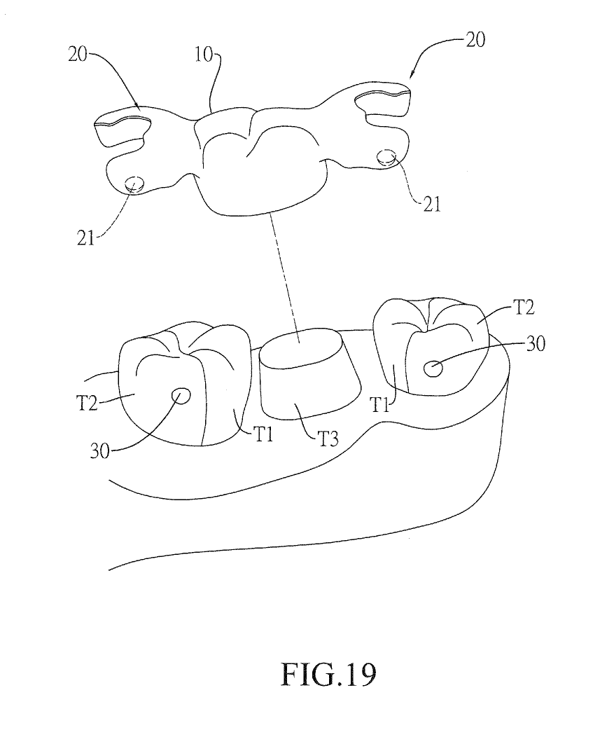

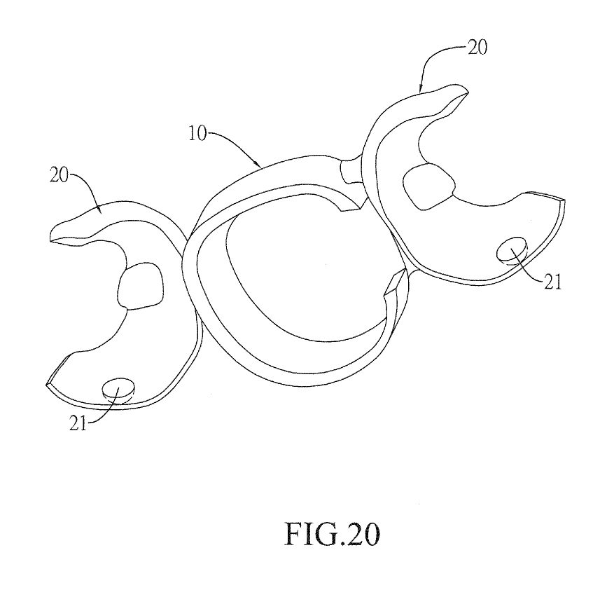

Using internal and external crowns that are coupleable with each other is one of the known ways of the conventional prosthetic dental device tooth. As shown in FIGS. 15-20, the prosthetic tooth 10 is made in the form of external crown that is fit over and attached to a preset internal crown T3, and the prosthetic tooth 10 (which is an external crown shown in the drawings) is provided at one or two sides of with a bridge clasping arm 20. This is a different embodiment of the present invention.

Further, there may be two bridge clasping arms 20 respectively arranged at two sides of the prosthetic tooth 10, so as to ensure uniform distribution of force applied to both sides of the prosthetic tooth 10 and thus improve the capability of the prosthetic tooth for bearing forces acting thereon. It is apparent that, as mentioned previously, the prosthetic tooth 10 can be modified to comprise a number of prosthetic teeth connected to each other and a bridge clasping arm 20 is arranged at each of the two side teeth. This is considered within the scope of protection sought by the present invention.

The present invention offers such an advantage of easy mounting and removal and adopts a bridge clasping arm 20 to improve the capability of bearing force acting thereon. A user may easily remove the prosthetic device for cleaning and re-mounted again all by himself and herself, showing excellent convenience.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A prosthetic tooth having a bridge clasping arm and a clasping structure, comprising:
a prosthetic tooth; and
at least one bridge clasping arm, which is connected to one side of the prosthetic tooth and comprises:
a first clasping portion, which is formed on an inside surface of the bridge clasping arm;
wherein a second clasping portion is provided on an adjacent tooth, which corresponds to the bridge clasping arm, whereby when the bridge clasping arm is positioned on the adjacent tooth, the first clasping portion and the second clasping portion engage each other for clasping.

2. The prosthetic tooth according to claim 1, wherein the bridge clasping arm further comprises a movable section, which is formed by partially cutting the bridge clasping arm to form a deflectable structure, the first clasping portion being formed on the movable section.

3. The prosthetic tooth according to claim 2, wherein the first clasping portion comprises a raised block and the second clasping portion comprises a corresponding recess.

4. The prosthetic tooth according to claim 3, wherein the second clasping portion is formed on an internal crown and is attached to the adjacent tooth through the internal crown.

5. The prosthetic tooth according to claim 4, wherein the prosthetic tooth is formed as an external crown.

6. The prosthetic tooth according to claim 5, wherein two bridge clasping arms are respectively connected to two sides of the prosthetic tooth.

7. The prosthetic tooth according to claim 1, wherein the first clasping portion comprises a raised block and the second clasping portion comprises a corresponding recess.

8. The prosthetic tooth according to claim 7, wherein the second clasping portion is formed on an internal crown and is attached to the adjacent tooth through the internal crown.

9. The prosthetic tooth according to claim 8, wherein the prosthetic tooth is formed as an external crown.

10. The prosthetic tooth according to claim 9, wherein two bridge clasping arms are respectively connected to two sides of the prosthetic tooth.

11. The prosthetic tooth according to claim 1, wherein the first clasping portion comprises a recess and the second clasping portion comprises a corresponding raised block, the second clasping portion being formed on an internal crown and attached to the adjacent tooth through the internal crown.

12. The prosthetic tooth according to claim 11, wherein the prosthetic tooth is formed as an external crown.

13. The prosthetic tooth according to claim 12, wherein two bridge clasping arms are respectively connected to two sides of the prosthetic tooth.

14. The prosthetic tooth according to claim 2, wherein the first clasping portion comprises a recess and the second clasping portion comprises a corresponding raised block, the second clasping portion being formed on an internal crown and attached to the adjacent tooth through the internal crown.

15. The prosthetic tooth according to claim 14, wherein the prosthetic tooth is formed as an external crown.

16. The prosthetic tooth according to claim 15, wherein two bridge clasping arms are respectively connected to two sides of the prosthetic tooth.
